(19) United States
(12) Patent Application Publication
(10) Pub. No.: US 2007/0005754 A1
(43) Pub. Date: Jan. 4, 2007

(54) Systems and methods for triaging attention for providing awareness of communications session activity

(75) Inventors: Eric J. Horvitz, Kirkland, WA (US); Peter S. Ford, Carnation, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/172,476

(22) Filed: Jun. 30, 2005

(51) Int. Cl. G06F 15/173

(52) U.S. Cl. 709/224

(57) ABSTRACT

The present invention provides systems and method to assist users in monitoring multiple communications sessions such as from electronic chat rooms, for example. The system allows the user to set certain settings for each chat room, wherein the settings or thresholds pertain to data associated with participants and activity of the sessions. The user then receives notifications when certain events occur in a given chat room. This enables the user to monitor various activities at multiple chat rooms, without having to pay attention or read each entry at each chat room or session.

### BACKGROUND OF THE INVENTION

Currently, users can engage in various real time communications sessions on their computers from substantially any location in the world. In one example of these communications, a chat room is an on-line, real-time conversation program that combines text-based chat with graphical features in many cases. Chat provides users the ability to locate users in different chat rooms, connect to multiple rooms using one nickname (nic), and display multiple rooms while chatting. Some chat rooms and chat applications (e.g., Internet Relay Chat or IRC) offers users the opportunity to incorporate audio and video into their communication (e.g., via pop-ups). Generally, users enter a chat room using a nickname that they have personally selected.

In chat, users communicate by typing or by using acronyms and typed gestures to emulate or express human thoughts, emotions or exclamations, for example. As can be appreciated however, electronic communications can take on many forms other than merely establishing a single chat session. Thus, in many cases, some users may participate in multiple chat sessions in a concurrent manner by frequently and manually monitoring activities from various groups before deciding to participate in any one group. Given a user's current work load or other activities, participating in multiple communications sessions may be problematic for many users or nearly impossible for some given their abilities to multiplex tasks. Also, participating in a respective session may waste time in that some users may only want to participate if certain activities are occurring, certain topics or conversations happening, or if certain users happen to be participating. In more sophisticated real time communications sessions, such as in an industrial setting, a control room operator may have to interface with several interfaces to machines and receive communications from many people in a concurrent manner. These type of concurrent interrupts can task even the most experienced people or operators when determining which situation should be attended to or prioritized before attending to other lower priority communications.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention relates to systems and methods for providing awareness from multiple communications sessions by automatically monitoring activities such as from chat rooms or other type of sessions. An automated system apprises users regarding situations or conversations that the user may be interested in or should be made aware of. The system allows users to participate in multiple communications sessions without requiring the user to pay full attention to any particular session, wherein the sessions can relate to chat rooms, instant message threads, business applications, defense applications and industrial or control room situations, for example. A logic component for triaging sessions couples alerting and cost models for when to engage a user from a particular session with considerations of the user's current workload, for example. Decision-theoretic principles can also be applied to weigh the cost of interrupting the user versus the benefits of notifying the user at a given time and from a detected change in session. Also, bounded deferral policies can be applied by the logic component to resolve notifying users from competing sessions that may be potential or possible selections for gaining the user's present or near term attention.

The system includes one or more communications sessions that may be directed to users from a plurality of sources. Activities from the respective sessions are monitored by the logic component for changes that may be of interest or importance to the user. Based upon detected changes, the logic component provides alerts or connections from one or more of the sessions to the user. For instance, the sessions may apply to one or more chat room conversations that are being run concurrently by the user. The logic component monitors for changes in the sessions to determine if an alert regarding a respective session should be presented to the user. The alert can be a temporary notice that a chat should be attended to based upon detected changes of interest or include more direct approaches such as moving an interface for a session to the top of a desktop at the user's focus of attention.

In one example, the user may be connected to a sports room chat, a: newsgroup chat, and a personal group chat, for example. Based on recent activities from any of the sessions, the logic component may bring to the user's attention an interface or other notice from a selected session (e.g., sports topic has changed from the Giants to the Yankees). This can include detecting a plurality of activities such as detecting preferred users who have recently entered a chat, changes in subject matter or session activity, changes in the number of participants, and from a plurality of other factors.

To the accomplishment of the foregoing and related ends, certain illustrative aspects of the invention are described herein in connection with the following description and the annexed drawings. These aspects are indicative of various ways in which the invention may be practiced, all of which are intended to be covered by the present invention. Other advantages and novel features of the invention may become apparent from the following detailed description of the invention when considered in conjunction with the drawings.

### BRIEF DESCRIPTION OF THE DRAWINGS

FIG. 1 is a schematic block diagram illustrating a communications architecture for triaging communications sessions in accordance with an aspect of the present invention.

FIG. 2 is a block diagram illustrating a logic component for triaging communications sessions in accordance with an aspect of the present invention.

FIG. 3 is a block diagram illustrating machine learning principles that can be applied in accordance with an aspect of the present invention.

FIG. 4 illustrates example user interface aspects in accordance with an aspect of the present invention.

FIG. 5 illustrates example applications in accordance with an aspect of the present invention.

FIG. 6 illustrates example communications sessions in accordance with an aspect of the present invention.

FIG. 7 illustrates bounded deferral policies in accordance with an aspect of the present invention.

FIG. 8 illustrates an example prioritization and notification system in accordance with an aspect of the present invention.

FIG. 9 is a flow diagram illustrating a process for triaging communications in accordance with an aspect of the present invention.

FIG. 10 is a schematic block diagram illustrating a suitable operating environment in accordance with an aspect of the present invention.

FIG. 11 is a schematic block diagram of a sample-computing environment with which the present invention can interact.

### DETAILED DESCRIPTION OF THE INVENTION

The present invention relates to systems and methods that automatically notify users of information changes from a plurality of real time communications sessions. Chat rooms, for example, have been growing in popularity in several domains, from consumer-centric special interest groups, to product support teams, to military coordination. It is thus difficult to track multiple chat groups. The subject invention addresses the challenge of maintaining an awareness of chat rooms by allowing users to specify preferences about being made aware of interactions they are most interested in. In one aspect, a system is provided that facilitates triaging between multiple communications sessions. The system includes interfaces for establishing at least two communications sessions that provide real time electronic information from users or machines. A logic component determines whether to alert a user regarding at least one of the communications sessions based at least in part on activity data associated with the sessions.

As used in this application, the terms “component,” “service,” “model,” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Furthermore, inference can be based upon logical models or rules, whereby relationships between components or data are determined by an analysis of the data and drawing conclusions therefrom. For instance, by observing that one user interacts with a subset of other users over a network, it may be determined or inferred that this subset of users belongs to a desired social network of interest for the one user as opposed to a plurality of other users who are never or rarely interacted with.

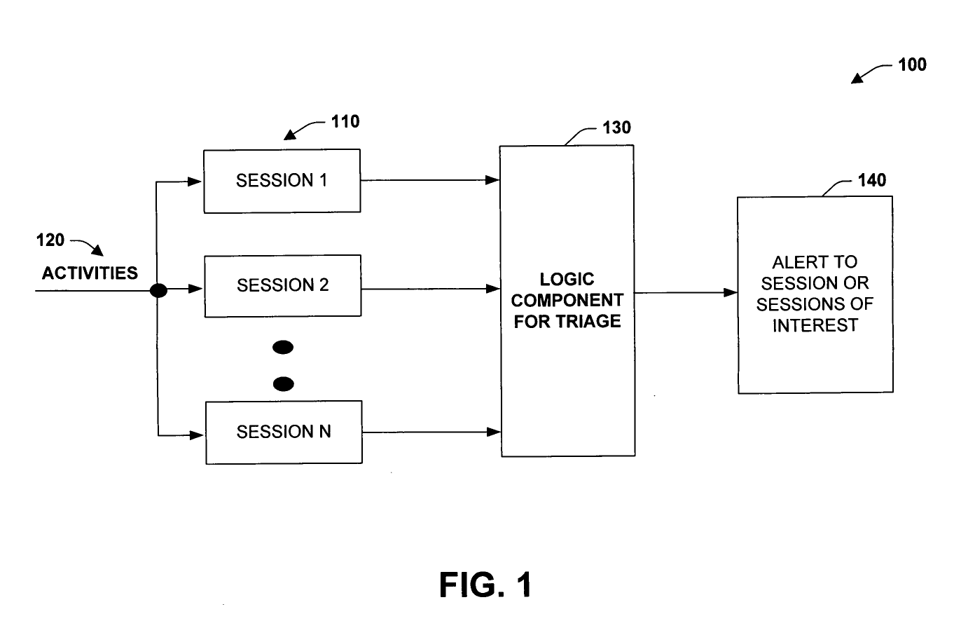

Referring initially to FIG. 1, a system 100 illustrates a communications architecture for triaging communications sessions in accordance with an aspect of the present invention. The system 100 includes one or more communications sessions 110 that may be directed to users from a plurality of sources. Activities 120 from the respective sessions 110 are monitored by a logic component 130 for changes that may be of interest or importance to a user. Based upon detected changes, the logic component 130 provides alerts or connections 140 from one or more of the sessions to the user. For instance, the sessions 110 may apply to one or more chat room conversations that are being run concurrently by a user. The logic component 130 monitors for changes in the sessions 110 to determine if an alert 140 regarding a respective session should be presented to the user. As will be described in more detail below, the alert 140 could be a temporary notice that a chat should be attended to based upon detected changes or include more direct approaches such as moving an interface for a session to the top of a desktop at the user's focus of attention, for example.

In one example, the user may be connected to a political group chat, a newsgroup chat, and a personal group chat, for example. Based on recent activities 120 from any of the sessions 110, the logic component 130 may bring to the user's attention 140 an interface or other notice from a selected session (e.g., news topic has changed from politics to the environment). This can include detecting a plurality of activities 120 such as detecting key users who have recently entered a chat, changes in subject matter or session activity, changes in the number of participants, and from a plurality of other factors which are described in more detail below. It is to be appreciated that the system 100 can be applied to substantially any type of communications session 110 in addition to the chat room example described above.

In general, the system 100 apprises users at 140 regarding situations or conversations that the user may be interested in or should be made aware of (e.g., alert whenever user X enters this chat, alert whenever the number of users discussing baseball exceeds ten). The system 100 thus allows users to participate in multiple communications sessions 110 without requiring the user to pay full attention to any particular session. As will be described in more detail below, the sessions 110 can relate to chat rooms, message threads, business or work applications, defense applications and industrial or control room situations, for example. The logic component 130 can couple alerting and cost models for when to engage a user from a particular session 110 with considerations of the users current workload, for example. Decision-theoretic principles can also be applied to weigh the cost of interrupting the user versus the benefits of notifying the user at a given time. Also, bounded deferral policies can be applied by the logic component 130 to resolve notifying users from competing sessions that may be potential or possible candidates for gaining the user's present or near term attention.

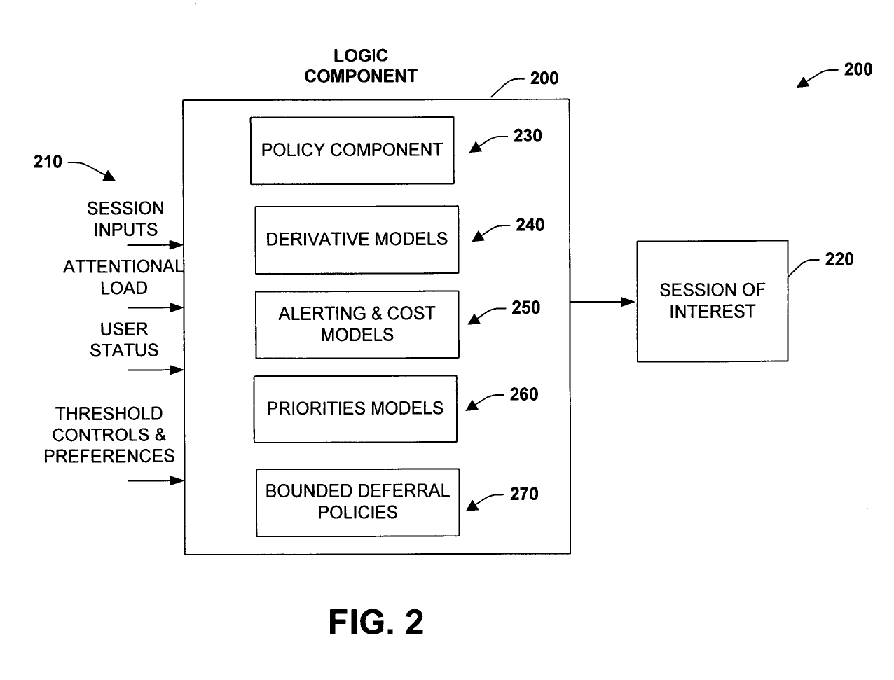

Referring now to FIG. 2, a user model 200 for automatically triaging communications sessions is illustrated in accordance with an aspect of the present invention. The user model 200 can consider information or data from a plurality of sources or inputs 210 when determining which real time communication session of interest should be provided or brought to the user's attention at 220. These sources 210 can include data or inputs from one or more sessions, considerations of the users attentional load, the users status (explicitly or implicitly determined) (e.g., I am busy, or reading email), and can include inputs, preferences or threshold settings for specifying/detecting when notifications or alerts should be provided. For instance, the logic component 200 may include control components that monitor communications parameters for predetermined levels. If a parameter exceeds the predetermined level, the logic component 200 can activate or notify the user of the detected change at 220 (e.g., if the rate of conversation or words is detected to be greater than X words per minute as the threshold, then notify the user of increased chat activity).

Generally, the logic component 200 supplies/processes a set of abstractions for users with respect to being alerted about changes in communications such as in a chat room, for example. At 230, the logic component can include rule-based policies, such as for example:

Let user know when:

Users in groups x begin to contribute to a chat room.

Users in group x enter a chat room

Users begin to contribute at some rate

Activity overall increases

Topic changes

More powerful approaches employ statistical classifiers, for example taking as input dynamics of conversation, including rates, numbers of participants, and content being discussed. Alerting thresholds can be made a function of the workload of users, including the use of inferences about the attention load of users, policies that specify busy-ness, and such functions as the number of active chat groups being managed and alerting from other chat rooms.

Proceeding to 240, one or more derivative models may be employed by the logic component 200 for detecting changes (e.g., models that apply 1^{st} order derivatives to detect change or calculate data changes over time). These can include monitoring various sites for data such as the change in number of words, the change in users, change in content or topic, and so forth. If a change exceeds a parameter change threshold for instance, the user can be notified at 220.

At 250, the logic component may employ one or more alerting and/or cost models when determining when/how to notify users. This can include a determination when to alert the user of a high-priority text, for example, a text that has a likelihood of being high priority greater than a user-set threshold, or greater than a threshold determined by decision-theoretic reasoning. That is, beyond knowing about time-critical messages, it can also be important to decide when to alert a user to time-critical messages if the user is not directly viewing incoming sessions, for example. In general, a cost of distracting the user from the current task being addressed to learn about the time-critical message is determined.

Alternatively, various alerting policies for alerting and notification can be employed. These policies can be implemented within a notification platform architecture, for example, that is described in more detail below. Some of these policies include: Setting a user-specified upper bound on the total loss. This policy would specify that a system should generate an alert when the total loss associated with the delayed review of a message exceeds some pre-specified “tolerable” loss “x”. Another policy can be a cost-benefit analysis based on more complete decision-theoretic analysis, such as NEVA=EVTA-ECA−TC, wherein NEVA is the net expected value of alerting, EVTA is the expected value of alerting, ECA is the expected cost of alerting, and TC is the transmission cost associated with communicating a message.

In general, a user should be alerted when a cost-benefit analysis suggests that the expected loss the user would incur in not reviewing the message or session at time t is greater than the expected cost of alerting the user. That is, alerting should be conducted if:
EL−EC>0

wherein EL is the expected loss of non-review of the text at a current time t,
and
   EC is the expected cost of alerting the user of the text at the current time t.

Information from several sessions can be grouped together into a single compound alert. It is also useful to know how busy the user is in making decisions about interrupting the user with information about sessions with high time criticality. It can be reasoned (e.g., inferential decision-making) about whether and the rate at which a user is working on a computer, or whether the user is on the telephone, speaking with someone, or at a meeting at another location. Several classes of evidence can be employed to assess a user's activity or his or her focus of attention. A Bayesian network can then be utilized for performing an inference about a user's activity.

Alternatively, decisions as to when and how to alert users can be made by employment of a set of user-specified thresholds and parameters defining policies on alerting. User presence can be inferred based on mouse or keyboard activity, for example. Thus, a user can be enabled to input thresholds on alerting for inferred states of activity and non-activity, for example. Users can also input an amount of idle activity following activity wherein alerting will occur at lower criticalities. If it is determined that the user is not available based on the time that substantially no computer activity is detected, then messages can be stored, and are reported to the user in order of criticality when the user returns to interact with the computer. Furthermore, users can specify routing and paging options as a function of quantities including expected criticality, maximum expected loss, and value of alerting the user.

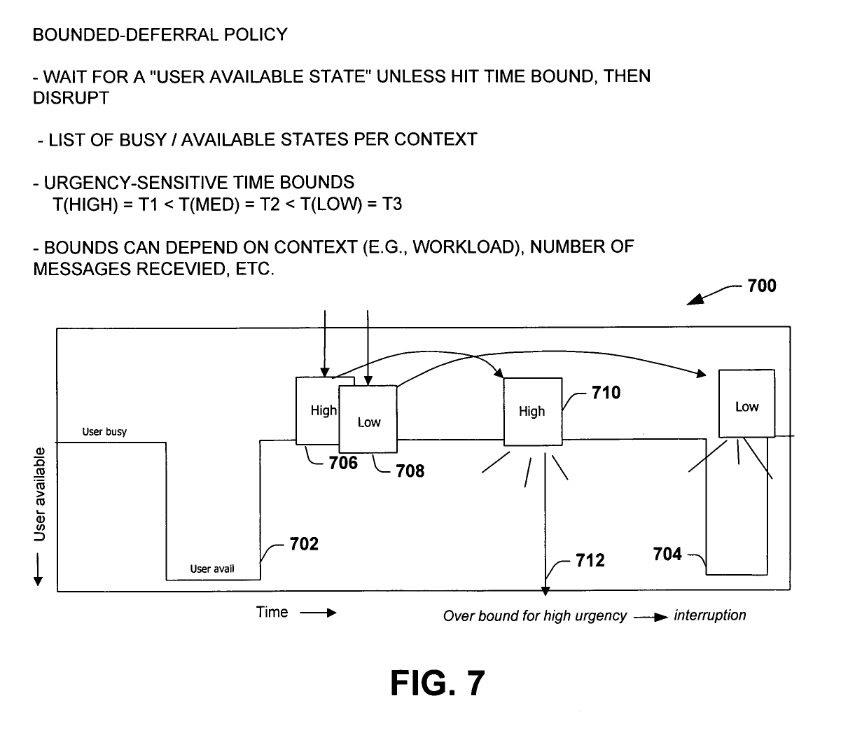

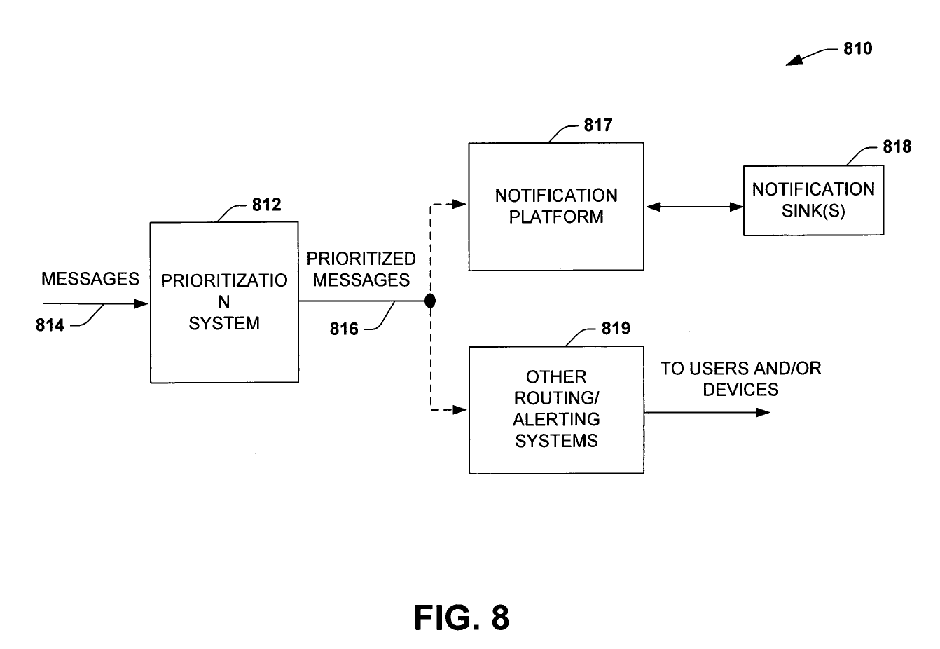

The logic model 200 can also include other components or analyzers for determining how and when to notify users of given session activity. For instance this can include a priorities model 260 for resolving different items of importance from a respective session, wherein such systems are described in more detail below with respect to FIG. 8. At 270, one or more bounded deferral policies may be employed to resolve differences of when to notify of particular chat room activities. For instance one session may indicate that items of medium priority has been detected whereas another session may indicate that items of high priorities have been detected. The bounded deferral policies are then employed to determine which of the two competing sections should provide notification and at what time. Such deferral policies are described in more detail with respect to FIG. 7 below.

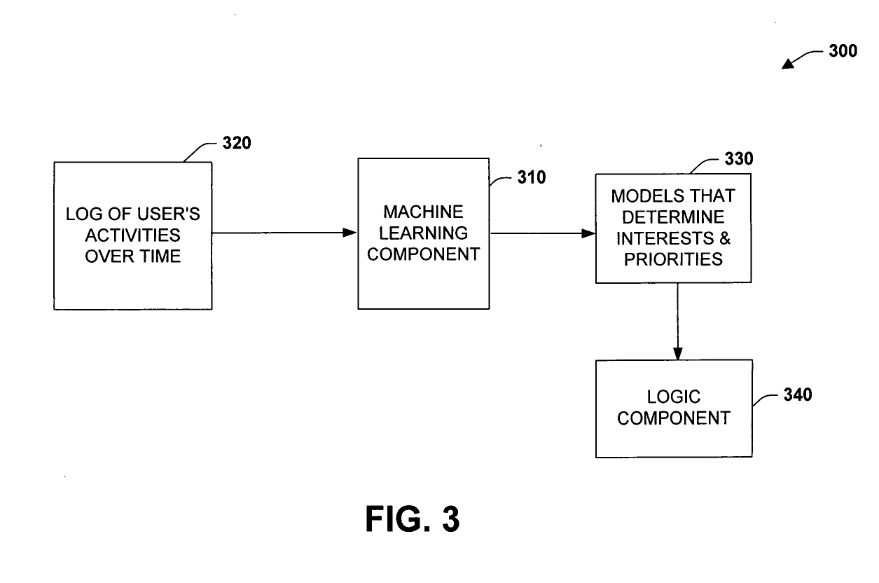

Turning now to FIG. 3, a system 300 illustrates machine learning principles that can be applied in accordance with an aspect of the present invention. In this case, rather than, or in furtherance of the user specifying preferences for how and when to be notified from a particular session, one or more machine learning components 310 can be employed to learn user characteristics over time to predict likely or possible preferences for notifying the user from a respective session. This can include analyzing a log of users activities over time at 320 to build trained models 330 that are then employed by a logic component 340 to triage between communications sessions. For instance, the models 310 can learn patterns such as the user's interests (e.g., user devotes much more time to sports than other subjects, when a particular person enters a chat the user monitors such person's conversations closely, from frequently visited web sites), the user's attention modes at given times, the user's preference for a particular session over another session, and substantially any information that can be gleaned from the log 320 that indicates preferences from the user.

As noted above, the machine learning component 310 employs learning models that can be applied to learn user characteristics and interests over time. The learning models can include substantially any type of system such as statistical/mathematical models and processes for modeling users and determining preferences and interests including the use of Bayesian learning, which can generate Bayesian dependency models, such as Bayesian networks, naive Bayesian classifiers, and/or Support Vector Machines (SVMs), for example. Other type models or systems can include neural networks and Hidden Markov Models, for example. Although elaborate reasoning models can be employed in accordance with the present invention, it is to be appreciated that other approaches can also utilized. For example, rather than a more thorough probabilistic approach, deterministic assumptions can also be employed (e.g., no recent searching for X amount of time of a particular web site may imply by rule that user is no longer interested in the respective information). Thus, in addition to reasoning under uncertainty, logical decisions can also be made regarding the status, location, context, interests, focus, and so forth of the users.

The learning models can be trained from a user event data store (log 320) that collects or aggregates data from a plurality of different data sources. Such sources can include various data acquisition components that record or log user event data (e.g., cell phone, acoustical activity recorded by microphone, Global Positioning System (GPS), electronic calendar, vision monitoring equipment, desktop activity, web site interaction and so forth). It is noted that the system 300 can be implemented in substantially any manner that supports personalized query and results processing. For example, the system could be implemented as a server, a server farm, within client application(s), or more generalized to include a web service(s) or other automated application(s) that interact with local or remote communications sessions.

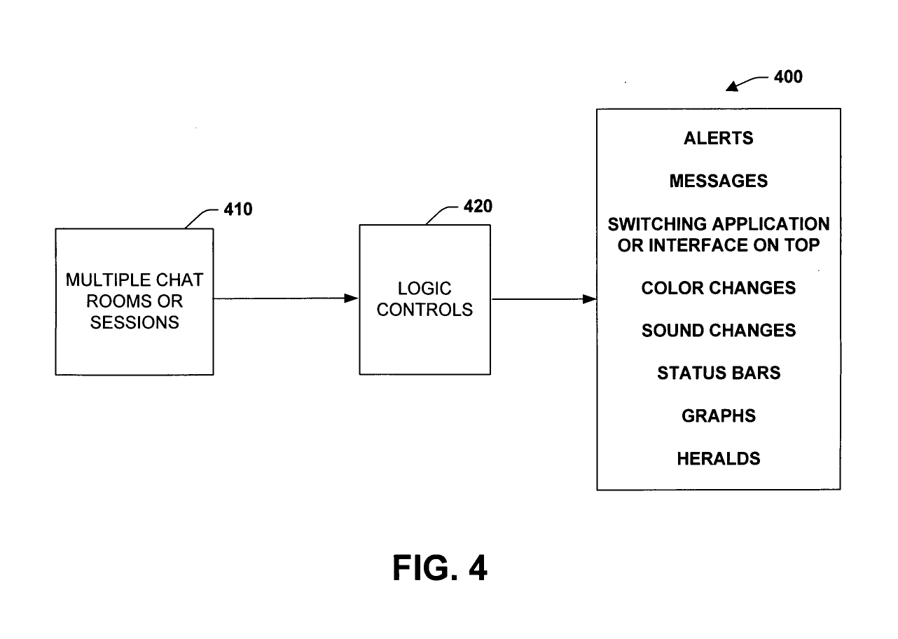

Referring now to FIG. 4, example user interface aspects are illustrated in accordance with an aspect of the present invention. An example user interface 400 is provided that illustrates some of the possible mechanisms for providing notice to a user from a respective communications session or sessions 410 during detected periods of change. Logic controls 420 such as previously described monitor the communications sessions 410, detect changes therein according to preferences of the user, before notifying the user of such changes in activities at the interface 400. Notice can be provided in varying forms at the interface 400. These notices can come in the form of alerts such as a pop-up display indicating a session the user may be interested in. This could also include messages (inside or outside applications or on the desk top) indicating changes in a session that may warrant the user's attention. Another form of notice includes switching a communications session interface to the focus of the user's attention such as bringing to the top (application window brought to the front as the active window) a session interface. This can include maximizing or minimizing interfaces or providing an indication that activities have changed (e.g., highlighting a session icon when communications activities change). Other indications can include session color changes, sound changes, status bars or graphs or more transient notices such as an information herald that appears briefly on a desk top indicating one or more sessions have changed.

It is noted that the respective interfaces described herein can be provided in various other different settings and context. As an example, interfaces for communications sessions or providing notice discussed herein can be associated with a desktop development tool, mail application, calendar application, and/or web browser, for example although other type applications can be utilized. These applications can be associated with a Graphical User Interface (GUI), wherein the GUI provides a display having one or more display objects (not shown) including such aspects as configurable icons, buttons, sliders, input boxes, selection options, menus, tabs and so forth having multiple configurable dimensions, shapes, colors, text, data and sounds to facilitate operations with the applications and/or models. In addition, the GUI and/or other components can also include a plurality of other inputs or controls for adjusting and configuring one or more aspects of the present invention. This can include receiving user commands from a mouse, keyboard, speech input, web site, remote web service, and/or other device such as a camera or video input to affect or modify operations of the GUI and/or components described herein.

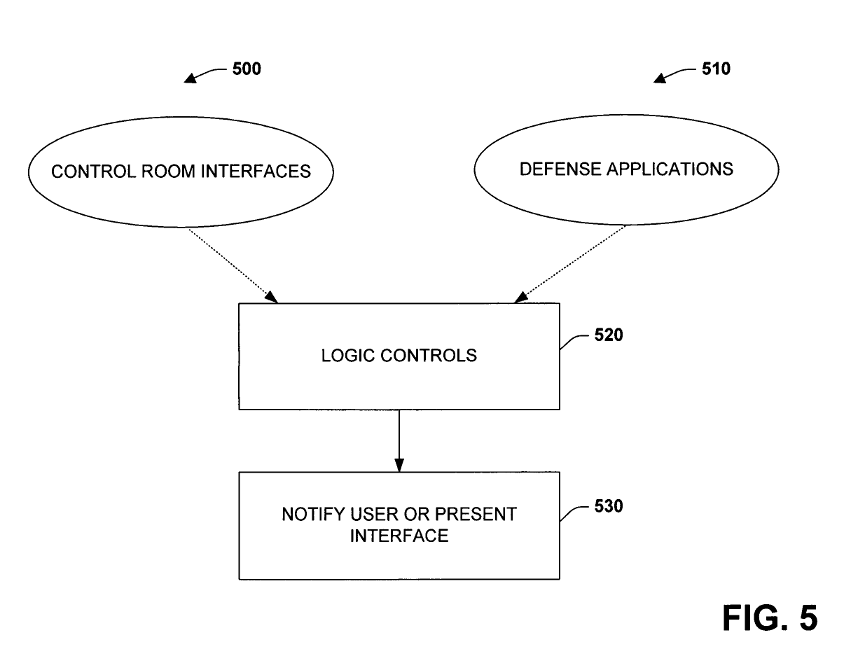

FIG. 5 illustrates example applications 500 and 510 in accordance with an aspect of the present invention. These applications can be monitored by logic controls 520 that detects changes in accordance with user preferences to notify users at 530. In one case, a control room situation is considered at 500. In this case, an operating may be monitoring many interfaces associated with a plurality of machines and controls. Also, one or more interfaces may provide communications from individuals in the course of plant operations. The logic controls 520 can be adapted such communications or activities from the machines or human sessions are monitored based upon preferences of the operator. For instance, during a maintenance procedure, the operator may load a profile that monitors maintenance interfaces for detected changes or conformance to specifications whereas other production interfaces can be given less importance during this procedure. During production, normal communications between plant floor people may not trigger notifying the operator to be aware of such communications. If words such as emergency or failure or problem are detected in a session for example, interfaces that have captured such communications can be automatically brought to the attention of the operator at 530 via the logic controls 520.

In another example, defense applications 510 can be considered. In these cases complex war or decision rooms can be monitored via the logic controls 520. Such interfaces may be tied into various branches of the services, wherein each branch is further subdivided. Preferences can be entered as noted above which then are employed to trigger bringing to the attention of decision makers in the room. For instance, one preference may be, if a general from this branch of the service enters a session, notify war room operator immediately. In another case, a policy could be established that if any users above a certain rank communicate, please notify the operator. Decisions can also be based upon other non-verbal activities such as notifications relating to battlefield operations, troop movements, casualties, assessments, intelligence and so forth.

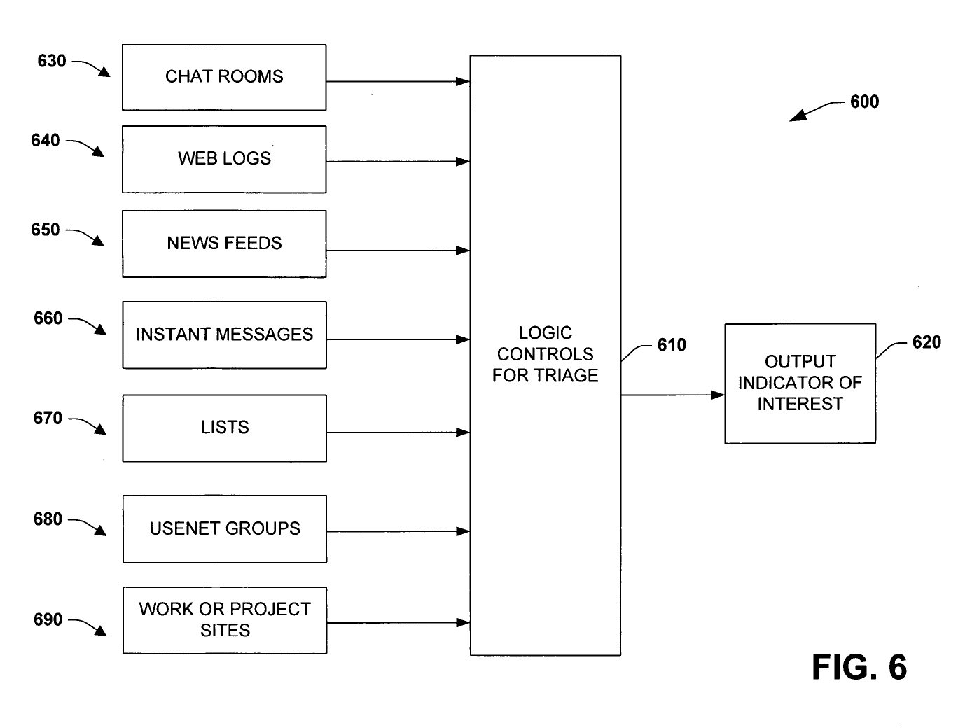

FIG. 6 a system 600 illustrates example communications sessions in accordance with an aspect of the present invention. In this aspect, logic controls 610 for triaging communications sessions are shown monitoring various types of communications sessions, wherein detected changes in accordance with user preferences trigger notification or output to a user at 620. It is noted that triaging can occur from different types or styles of sessions, wherein detected activities from respective sessions can cause notifications to the user. The sessions can include one or more chat rooms 630 as previously noted, wherein such chat can relate to various topic and groups. Other sessions can include monitoring web logs at 640, news feeds at 650, instant messages at 660, electronic lists at 670, usenet groups at 680, and/or work or project sites at 690. As can be appreciated, substantially any type of session that provides real time information or updated information can be monitored at 610 for changes that may result in notification to the user at 620.

FIG. 7 illustrates bounded deferral policies in accordance with an aspect of the present invention. According to this aspect, notifications or messages are not typically delivered until an available free state is reached unless a time bound is detected. For example, free states are illustrated at references 702 and 704. During busy states of the user (depicted as opposite to the free states 702, 704) a high and low priority message 706 and 708 are queued by a notification agent or manager (not shown). At 710, a time bound that was set as a max deferral time is reached for the high priority message and thus the high priority message is delivered to the user at 712. The low priority message 708 does not reach a time bound in the illustrated example of FIG. 7. Thus, the low priority message is not delivered until the next available free state at 704. In this manner, disruptiveness of notifications received by the user is mitigated. It is noted, that the time bounds can be influenced by the users context such as workload, number of messages received, and the time dependency of the notification content.

On average, because of the typical smatter of “likely available” states during typical desktop or endpoint device activities, most notifications will tend to be delivered before the max deferral times. However, user's will be more pleased on average with the notification system as notifications will tend more so to occur when the user is free than they would have been had notifications simply been passed through when notifications are received. The probability that a free state will be reached generally increases with time-as there are more opportunities for detecting a likely available state with increasing amounts of time. As the probability of a likely free state increases with increasing amounts of times, lower priority messages will tend to occur with higher-likelihood during these likely free states, and the probability of being disrupted will grow with the increasing priority of the messages.

FIG. 8 illustrates an example prioritization and notification system in accordance with an aspect of the present invention. A system 810 illustrates a prioritization system 812 and notification architecture. The prioritization system 812 receives one or more messages or notifications 814, generates a priority or measure of importance (e.g., probability value that the message is of a high or low importance) for the associated message, and provides the one or more messages with an associated priority value at an output 816. Classifiers can be constructed and trained to automatically assign measures of prioritization to the messages 814. For example, the output 816 can be formatted such that messages are assigned a probability that the message belongs in a category of high, medium, low or other degree category of importance.

The messages can be automatically sorted in an in box of an e-mail program (not shown), for example, according to the determined category of importance. The sorting can also include directing files to system folders having defined labels of importance. This can include having folders labeled with the degree of importance such as low, medium and high, wherein messages determined of a particular importance are sorted to the associated folder. Similarly, one or more audio sounds or visual displays (e.g., icon, symbol) can be adapted to alert the user that a message having a desired priority has been received (e.g., three beeps for high priority message, two beeps for medium, one beep for low, red or blinking alert symbol for high priority, green and non-blinking alert symbol indicating medium priority message has been received).

According to another aspect of the present invention, a notification platform 817 can be employed in conjunction with the prioritization system 812 to direct prioritized messages to one or more notification sinks accessible to users. The notification platform 817 can be adapted to receive the prioritized messages 816 and make decisions regarding when, where, and how to notify the user, for example. As an example, the notification platform 817 can determine a communications modality (e.g., current notification sink 818 of the user such as a cell phone, communications session to display, or Personal Digital Assistant (PDA)) and likely location and/or likely focus of attention of the user. If a high importance e-mail were received, for example, the notification platform 817 can determine the users location/focus and direct/reformat the message to the notification sink 818 associated with the user. If a lower priority message 816 were received, the notification platform 817 can be configured to leave the e-mail in the user's in-box for later review as desired, for example.

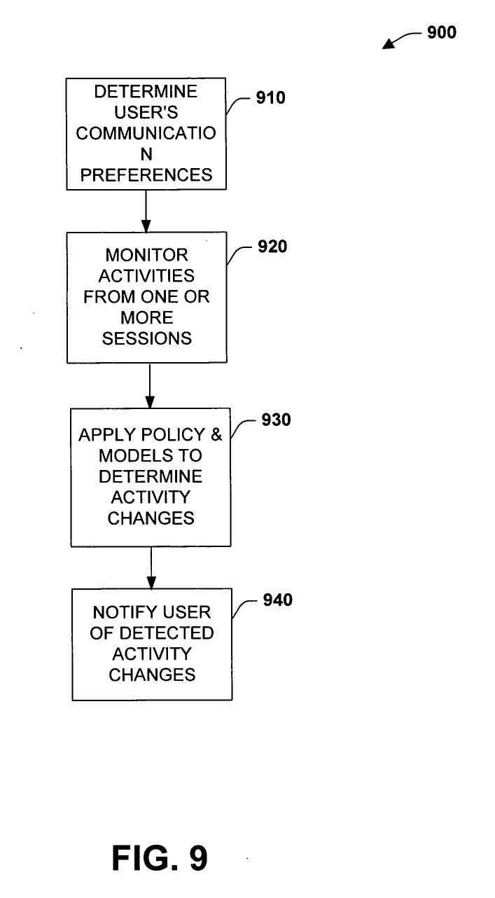

FIG. 9 illustrates a process 900 for triaging communications in accordance with an aspect of the present invention. While, for purposes of simplicity of explanation, the methodology is shown and described as a series of acts, it is to be understood and appreciated that the present invention is not limited by the order of acts, as some acts may, in accordance with the present invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

Proceeding to 900, user's communications preferences are determined. This can include receiving inputs from interfaces that modify rules, policies, or models for when and how to notify users of a change from a communications session such as a chat room, for example. Such settings can include identifying a person or persons of interest that may have entered a respective session, entering threshold parameters specifying activity levels for a chat room (e.g., number of words encountered per second), and specifying particular topic of interest for example. As can be appreciated, a plurality of preferences can be specified for monitoring and detecting changes in a communications session. At 910, activities from one or more sessions are monitored. As noted above, this can involve monitoring users who enter a session, monitoring word or conversation frequencies, and other factors such as the type or quantity of users who enter a respective session.

At 930, one or more models or policies are applied to the communications sessions to determine changes that may occur with a respective session. This can include policy component for monitoring session content or individuals associated with a session, alerting and cost models, derivative models for detecting changes, priorities models, bounded deferral policies, and/or machine learning models. At 940, the user is notified of session activity based upon detected changes at 930. This can include bringing a session interface to the user's attention or providing notice that a session of interest should be attended to based upon the preference settings of 910.

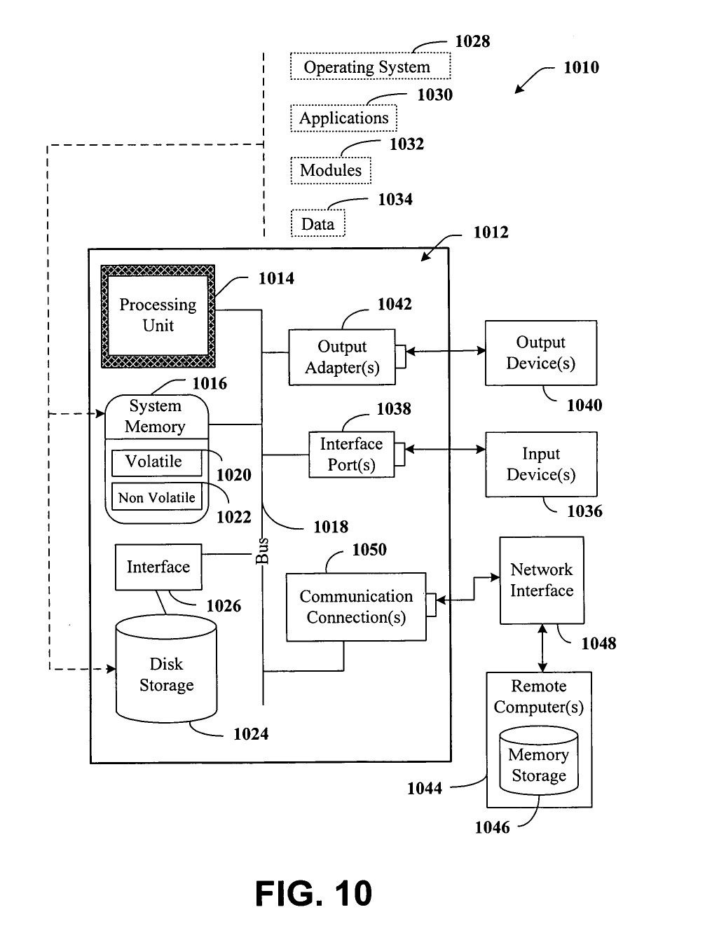

With reference to FIG. 10, an exemplary environment 1010 for implementing various aspects of the invention includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the present invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

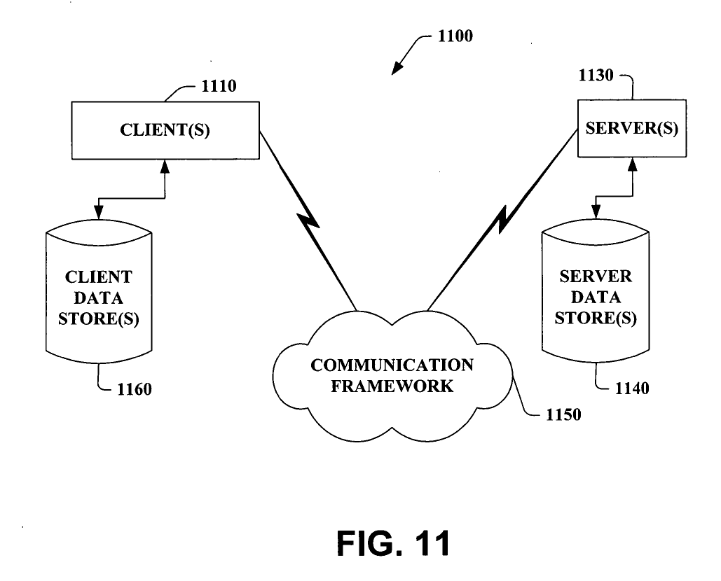

FIG. 11 is a schematic block diagram of a sample-computing environment 1100 with which the present invention can interact. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1130 can house threads to perform transformations by employing the present invention, for example. One possible communication between a client 1110 and a server 1130 may be in the form of a data packet adapted to be transmitted between two or more computer processes. The system 1100 includes a communication framework 1150 that can be employed to facilitate communications between the client(s) 1110 and the server(s) 1130. The client(s) 1110 are operably connected to one or more client data store(s) 1160 that can be employed to store information local to the client(s) 1110. Similarly, the server(s) 1130 are operably connected to one or more server data store(s) 1140 that can be employed to store information local to the servers 1130.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates triaging between communications sessions, comprising:
at least one communications session that provides real time electronic information from users or machines; and
a logic component to determine whether to generate an alert regarding the communications session based at least in part on activity data associated with the session.

2. The system of claim 1, the communications sessions are directed to users from a plurality of electronic information sources.

3. The system of claim 1, the activity data is monitored by the logic component for changes that are of interest or importance to a user.

4. The system of claim 3, the interest or importance is specified by one or more settings of user preferences.

5. The system of claim 4, the settings relate to specifying a person, a group of people, a topic of interest, and a rate at which communications commence.

6. The system of claim 1, the logic component includes a policy component for processing user preferences.

7. The system of claim 1, the logic component includes a derivative model for detecting communications changes.

8. The system of claim 1, the logic component includes an alerting and cost model to weigh the cost and benefits of alerting a user now or in the future in view of the user's current workload.

9. The system of claim 1, the logic component includes a priorities model to determine an importance for dialog in a communications session.

10. The system of claim 1, the logic component includes a bounded deferral model for resolving when to notify users from a plurality of communications sessions

11. The system of claim 1, the logic component analyzes at least one of a session input, an attentional load associated with a user, a user status, and a threshold input to determine when to notify a user from a communications session.

12. The system of claim 1, further comprising one or more machine learning components to determine user preferences over time.

13. The system of claim 1, the communications session is associated with at least one user interface to relay information from the session.

14. The system of claim 13, further comprising notifications that are provided to the interface via at least one of an alert, a message, a color change, a size change, a sound change, a status bar, a graph, and an information herald.

15. The system of claim 14, the notifications are provided by switching an application to a user's focus of attention.

16. The system of claim 1, the communications session is related to at least one of a defense application and a control room application.

17. The system of claim 1, the communications session is related to at least one of a chat room, a web log, a news feed, an instant message, an email, an electronic list, a usenet group, a work site, and a project site.

18. A communications system for exchanging real time information, comprising:
means for specifying preferences relating to a communications session;
means for modeling the preferences; and
means for generating alerts relating to at least one communications session based at least in part on the preferences.

19. A method that facilitates controlling notifications at a user interface, comprising:
determining at least one parameter of interest relating to a user's preference for being notified of a communication;
defining a least one user model that automatically processes the parameters of interest; and
automatically triaging between communications sessions based in part on the preferences and the user model.

20. The method of claim 19, the preferences include identifying a person or persons of interest that may have entered the communications session, entering threshold parameters specifying activity levels for the session, a communicates rate, or specifying a topic.
